(19) United States
(12) Patent Application Publication
(10) Pub. No.: US 2009/0187438 A1
(43) Pub. Date: Jul. 23, 2009

(54) Method for review appraisals

(75) Inventor: Teresa A. Selberg, Urbandale, IA (US)

Correspondence Address: BRETT J. TROUT, PC, 516 WALNUT, DES MOINES, IA, 50309, US

(73) Assignee: SELBERG, LLC

(21) Appl. No.: 12/011,001

(22) Filed: Jan. 23, 2008

(51) Int. Cl. G06Q 99/00

(52) U.S. Cl. 705/7

(57) ABSTRACT

A system and method for reviewing property appraisals which provides reviewers with assessment parameters on a point by point basis for each input on a standard appraisal form and regulations via a computer network to input information regarding the review. The system automatically associates regulatory citations and language with negative assessment parameters identified by a reviewer. The reviewers upload the review information to a database via computer network where an administrator can access the review information, compiling the review information by various criteria to analyze trends and identify problems.

### BACKGROUND OF THE INVENTION

1. Field of the Invention

This invention relates in general to a system for reviewing appraisals and, in particular, to a system for promulgating and processing reviews of residential and commercial appraisals on a point by point basis.

2. Description of the Prior Art

Information is most valuable when it is collected quickly, accurately and in a manner which allows the information to be accessed efficiently. Property appraisals are typically done by licensed appraisers who follow a template uniform appraisal report. While the uniform appraisal reports attempt to limit the subjectivity of a particular appraiser as much as possible, no two properties are exactly alike. Accordingly, given the near infinite variability of the aspects of a property which may affect its value, even uniform appraisal reports allow for the subjectivity of the appraiser. This subjectivity is recorded on the appraisal report in the form of various assessments that the appraiser makes, as well as commentary that the appraiser may add to the appraisal report. Because the appraisal reports contain this element of subjectivity, the appraisal process cannot be completely automated.

When it is desired to review the accuracy of an appraisal report, the subjectivity inherent therein also limits the ability to automate the review process. Review of appraisal reports is necessary for licensure of appraisers and to enforce disciplinary action against appraisers found to be incompetent or fraudulent. As the review of appraisal reports is typically done by more highly skilled appraisers, a comprehensive review of every single appraisal report would be duplicative and nonfeasible. Although the review does not entail repeating every element of the appraisal, the sheer number of appraisal reports completed would require the full schedule of all of the most highly qualified appraisers simply to do nothing but reviews. Accordingly, appraisal reports are randomly selected for review. If the random selection uncovers an anomaly, additional appraisal reports from the particular appraiser may be selected for review as well. Although sampling works fairly well to identify problems with various appraisers, the subjective nature of the appraisal process itself, compounded by the subjective nature of the review process and the delays inherent in the review process, make the review process inherently inefficient.

Typically, a reviewer analyzes appraisals completed using a Uniform Residential Appraisal Report (URAR), a Federal National Mortgage Association (FNMA) report, a Federal Home Loan Mortgage Corporation (FHLM) report or similar, standardized form. The reviewer analyzes the appraisal report, notes any discrepancies inherent in the report, cites the appropriate uniform standards of professional appraisal practice (USPAP), and notes the appropriate standard, if any, at odds with the discrepancy in the appraisal report. The process of writing out each discrepancy, citing the USPAP reference, and forwarding the appraisal review report to the appropriate authority is difficult, often leading reviewers to put off the task as long as possible, thereby adding to the already long delay associated with the review process. During this delay, incompetent and fraudulent appraisers continue to damage individuals and businesses with inaccurate appraisal reports.

An additional drawback associated with the prior art is the inability to quickly access information contained in the appraisal review reports. Given the subjective nature of the appraisal process, slight deviations from the norm may go unnoted even by the most scrupulous of reviewers. However, the larger the amount of information that can be collected and compared, the more readily trends can be recognized. These trends may indicate an otherwise unnoticeable inflation of appraisals by a particular appraiser, for which disciplinary action may be undertaken, or may even indicate a statistically low set of appraisal values, which may indicate additional training is necessary for a particular appraiser. It would, therefore, be desirable to not only speed up the appraisal review process, but to allow the information contained within a large number of appraisal review reports to be readily accessible and comparable to determine trends. The difficulties encountered in the prior art discussed hereinabove are substantially eliminated by the present invention.

### SUMMARY OF THE INVENTION

Advantageously, this invention provides an efficient and accurate method for collecting and analyzing appraisal reviews.

Advantageously, this invention provides increased accessibility to data collected from appraisal reviews.

Advantageously, this invention provides a method for increasing appraisal review productivity.

Advantageously, this invention provides a faster and more inexpensive method of collecting and analyzing appraisal reviews.

Advantageously, this invention provides an improved method of spotting trends from information collected from appraisal reviews.

Advantageously, this invention provides an improved method for correlating appraisal reports errors with associated regulatory violations.

In an embodiment of this invention, a method of reviewing appraisals is provided. The method includes providing an appraisal from an appraiser to a reviewer. The reviewer analyzes each point on the appraisal form against a set of appraisal criteria and inputs a review of the appraisal through an interface system to be received by a database. In the preferred embodiment, a database of applicable federal (USPAP) regulations is associated with the review. An administrator compiles information from a plurality of appraisal reviews from the database to make disciplinary and licensure decisions based upon the data contained therein.

### BRIEF DESCRIPTION OF THE DRAWINGS

The present invention will now be described, by way of example, with reference to the accompanying drawings in which:

FIG. 1 illustrates a schematic of the appraisal review collection system of the present invention;

FIG. 2 illustrates a prior art appraisal report;

FIG. 3 illustrates a prior art appraisal review report;

FIG. 4 illustrates a flow diagram of a method of receiving, reviewing and taking action upon an appraisal according to the present invention;

FIG. 5 illustrates a screen shot of an administrator homepage according to an embodiment of the present invention;

FIG. 6 illustrates a screen shot of the review set detail above;

FIGS. 7A-7B illustrate a flow diagram of a method of a reviewer receiving and reviewing an appraisal according to an embodiment of the present invention;

FIG. 8 illustrates a screen shot of a reviewer homepage according to an embodiment of the present invention;

FIG. 9 illustrates a screen shot of a review set page according to an embodiment of the present invention;

FIG. 10 illustrates a screen shot of an assessment parameters page according to an embodiment of the present invention;

FIG. 11 illustrates a screen shot of a reviewer's review page of the present invention;

FIG. 12 illustrates a screen shot of the final reviewer's review page of the present invention;

FIGS. 13A-13C illustrate a finalized appraisal review according to an embodiment of the present invention; and

FIG. 14 illustrates a screen shot of an administrator search page according to an embodiment of the present invention.

### DETAILED DESCRIPTION OF THE PREFERRED EMBODIMENT

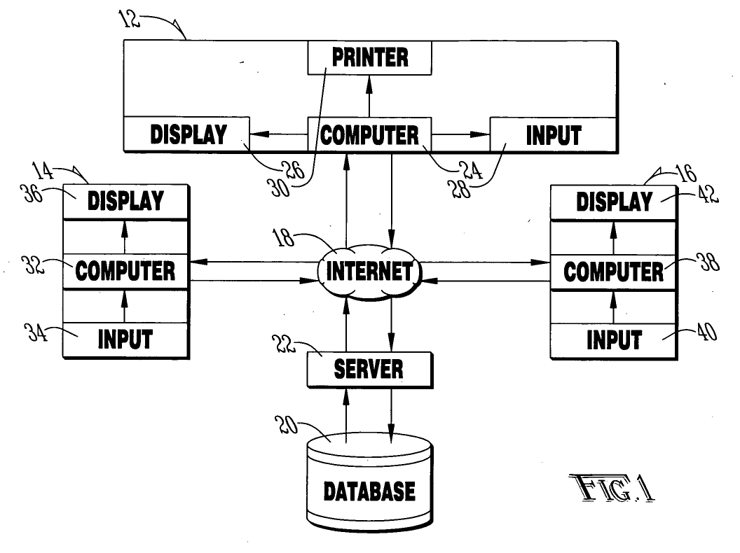

With reference to the drawings, an appraisal review system according to the present invention is shown generally as (10) in FIG. 1. Although the system (10) is preferably designed to address property appraisals, the system (10) may be utilized in association with any other desired assessments from any type of assessor, such as mortgage documents, loan underwriting, medical assessments, legal opinions, judicial decisions, accounting audits, etc. The system (10) includes a first administrator (12), a first reviewer (14) and a second reviewer (16), all coupled to a network such as the Internet (18). A database (20) is coupled to a server (22) which, in turn, is also coupled to the Internet (18).

As shown in FIG. 1, the administrator (12) is provided with a computer (24) which, in turn, is coupled to a display (26) an input (28), such as a keyboard, and a printer (30). Similarly, the first reviewer (14) is provided with a computer (32), a display (36) and an input (34). A second reviewer (16) is also provided with a computer (38), a display (40) and an input (42). As explained below, the appraisal review system (10) supports the initiation, tracking, management and completion of appraisal reviews on a point by point basis. In the preferred embodiment, the system (10) is provided for use in association with residential appraisals but may, of course, be utilized in association with any desired type of appraisal report.

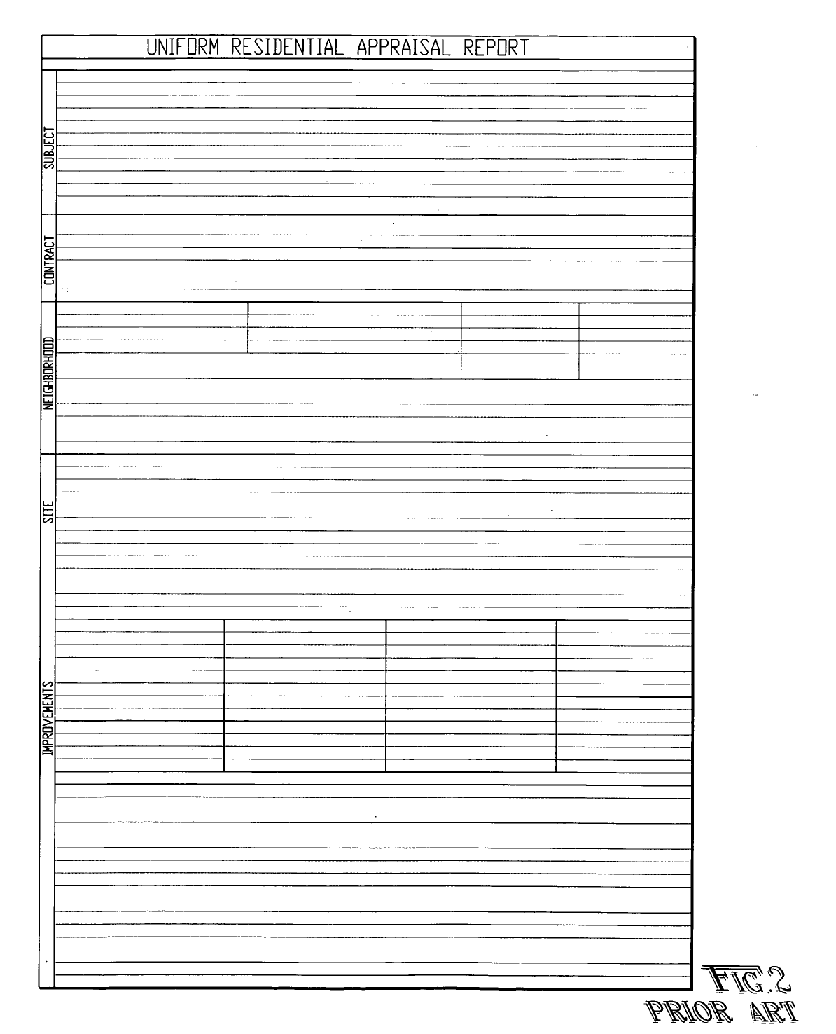

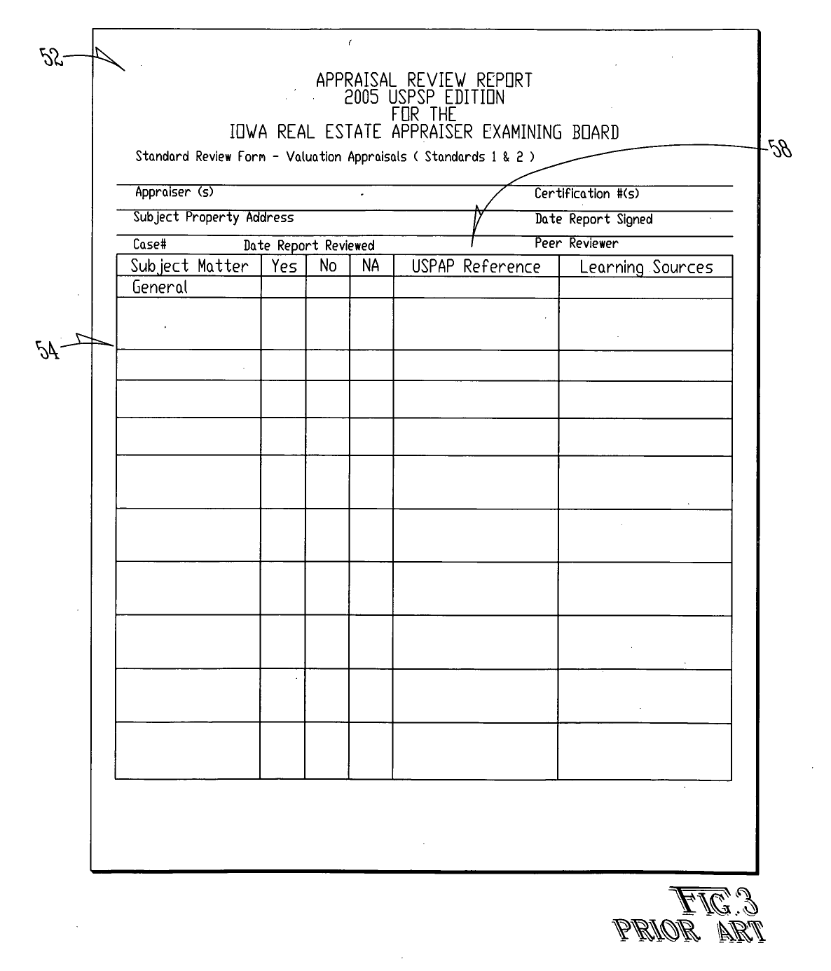

Evaluation authorities such as state boards, the Appraisal Subcommittee of the Federal Institutions Examination Council (ASC), mortgage lenders, other residential mortgage services and others can utilize the system (10) to assign appraisal reviews to individual reviewers and track the status of such reviews. The appraisal review system (10) of the present invention increases reviewer productivity by providing an appraisal review interface with a point by point “check” system for individual appraisal fields. Default values are provided for each field appearing in an appraisal review, allowing for the efficient capture of incorrect results or atypical appraisal information. A prior art appraisal report is shown generally as (44) in FIG. 2. The appraisal (44) contains objective textual information (46), check boxes (48) and subjective textual information (50). A prior art appraisal review report is shown generally as (52) in FIG. 3. The report (52) includes a plurality of subject matter categories (54), check boxes (56), indicating whether the subject matter has been addressed, USPAP reference categories (58) and learning sources (60).

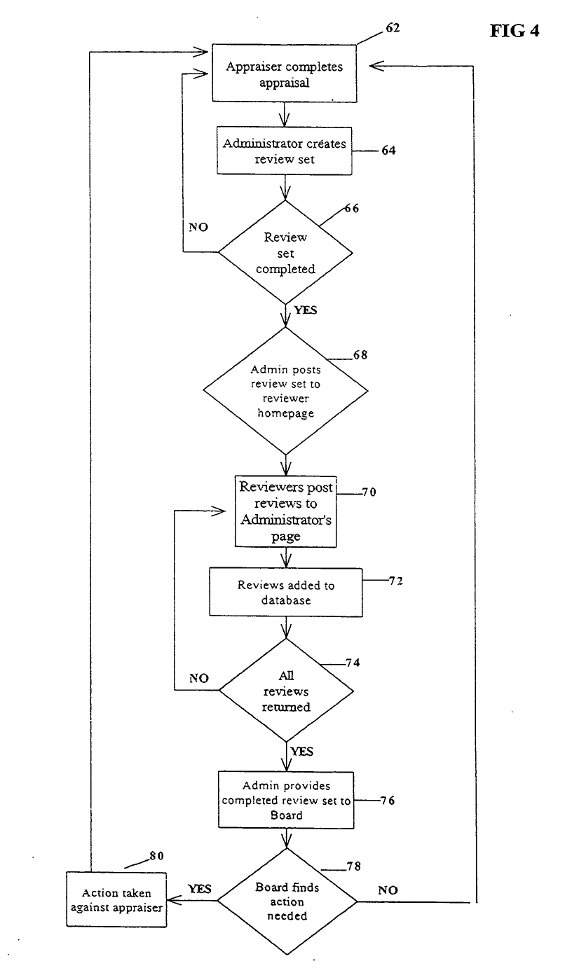

As shown in FIG. 4, the method of the present invention begins with step (62) with an appraiser completing an appraisal (44). (FIGS. 2 and 4). Once the appraisal (44) has been completed, the appraisal (44) is provided to the administrator (12). (FIGS. 1 and 4). The appraisal (44) may be provided directly to the administrator (12) in step (64), or the administrator (12) may obtain the appraisal (44) from an intermediate body. To create a review set, the administrator (12) selects a plurality of appraisals to be reviewed, such as work product reviews or disciplinary reviews. The administrator (12) may continue to add reviews until the review set contains all the desired reviews. The administrator (12) may add or subtract reviews from the review set at any time. As shown in step (66), once a predetermined number of appraisals (44) has been collected to constitute a review set desired by the administrator (12), the administrator (12) assigns (68) the review set to one or more reviewers (14) and (16) by making the review set viewable by a reviewer on the reviewer's homepage (116).

In step (66), if the requisite number of appraisals (44) have not been returned to the administrator (12) to constitute the desired review set, the process returns back to step (62) and continues until the requisite number of appraisals (44) have been collected to constitute the set desired by the administrator (12). Once the reviewers (14) and (16) receive the appraisals (44), the reviewers (14) and (16) complete the reviews on their computers (32) and (38). When the reviews are completed, the reviewers (14) and (16) make the completed reviews available for viewing by the administrator (12), preferably in PDF format, on the administrator's homepage (82) via the Internet (18). (FIGS. 1 and 4).

As shown in step (72), as the reviews are returned, the information contained within the reviews is added to the database (20). If all of the reviews have not been returned (74), the process returns to (70) with the reviews being collected and added (72) to the database (20) until all of the reviews, or at least the desired number of reviews, have been returned. Once all of the reviews have been returned, the administrator (12) in step (76) prepares the completed review set for presentation to a reporting authority or other authority which can store a copy of the completed review on their own computer system. As shown in step (78), if the reporting authority finds, based upon the completed review set that action (80) needs to be taken against a particular appraiser, the action (80) is taken and the process begins again with step (62). The present invention allows the reporting authority to base its actions upon section score numbers (200) and/or overall score (210), thereby reducing subjective bias which might otherwise insinuate itself into the decision to take a particular action. (FIGS. 1, 4 and 13a-b). The action (80) may be further investigation, revocation of licensure or other disciplinary action. If the reviews are favorable, the reporting authority may use the completed review set to grant a license to an appraiser, or upgrade the licensure of a particular appraiser. If the reporting authority does not find any action (80) needs to be taken, the process returns directly to step (62) and begins again.

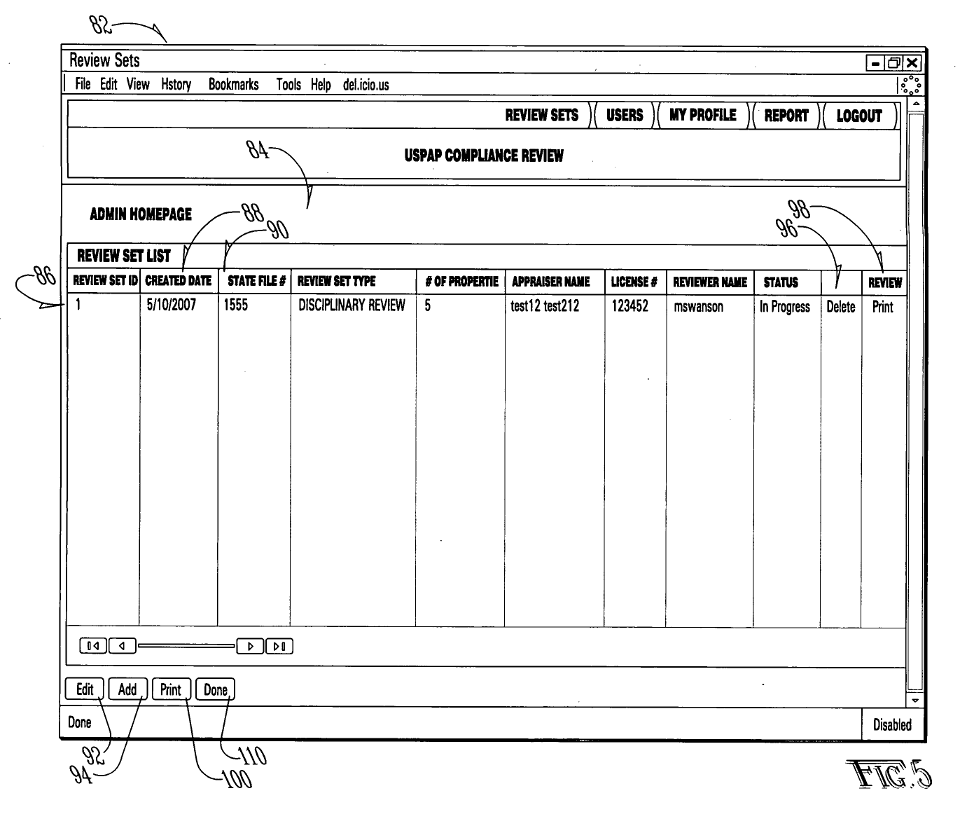

A screen shot associated with an administrator homepage interface to the appraisal review system (10) is shown generally as (82) in FIG. 5. The homepage (82) contains information (84) relating to specific reviews within the set, including review number (86), creation date (88), file number (90), etc. As shown, the homepage (82) includes an edit button (92). The edit button (92) allows the administrator (12) to add, subtract, or edit information relating to the review set or request reports. The homepage (82) also includes an add button (94) associated with the reviews which allows the administrator (12) to add additional reviews to the review set. The review numbers (86) are hyperlinks to webpages associated with each review to allow the administrator (12) to review individually. If it is desired to delete or print a particular review, “delete” hypertext (96) and “print” hypertext (98) are associated with each review. To prevent any subsequent editing, the print hypertext (98) prints the review as a PDF file for submission to a requesting entity, such as an appraisal board, governmental authority, corporation or any other review authority or agency.

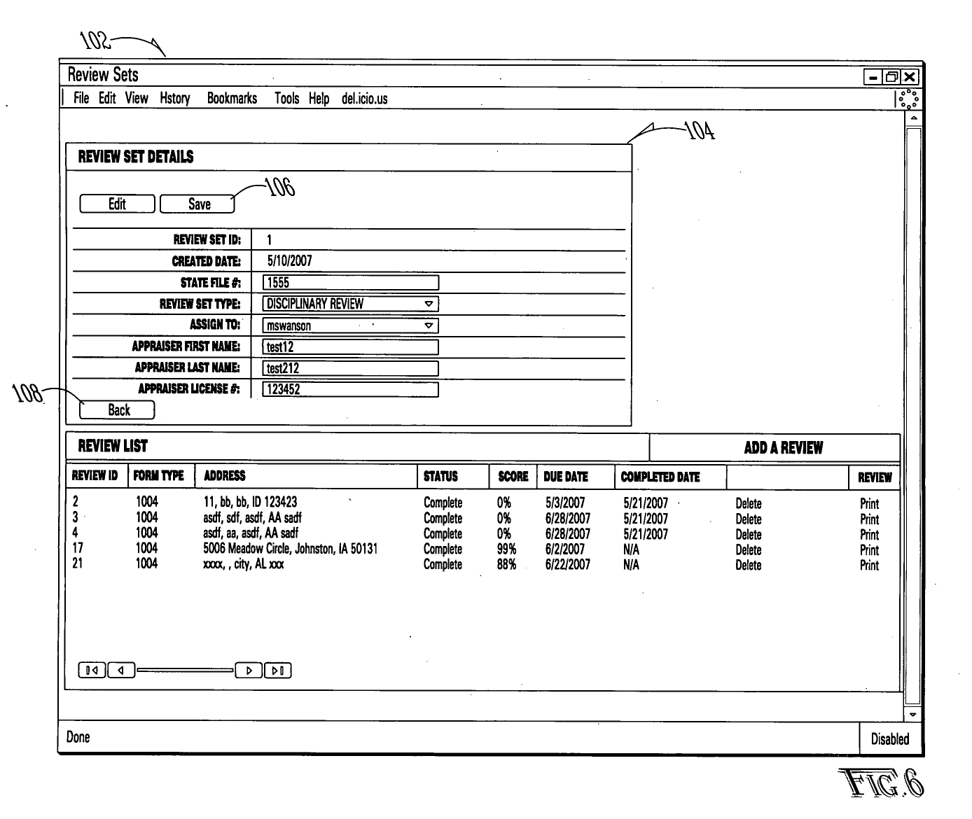

Once the administrator (12) has completed activity on the administrator's homepage (82), the administrator (12) can click the print review set button (100) to print the review set from the printer (30), or click the done button (110) to save the information on the homepage (82) and close the page. If the administrator (12) wishes to add a review to a review set, the administrator (12) clicks the add button (94) which takes the administrator (12) to the review set detail page, shown generally as (102) in FIG. 6. The review set details page (102) displays fields (104) which allow the administrator (12) to input an additional review into a review set. Once the administrator (12) has finished adding a review, the administrator (12) clicks the save button (106) and then the back button (108) for return to the administrator homepage (82).

As shown in FIGS. 1, 2, 7A, 7B and 8, a reviewer (14) receives (112) an appraisal (44) electronically, such as in PDF format or as a hard copy delivered by hand or by mail. The reviewer (14) then uses the computer (32) to log on (114) to the appraisal review system (10), using a unique user name and password associated with that particular reviewer (14). Shown generally as (116) in FIG. 8, is a screen shot associated with the homepage of a reviewer (14) for accessing the appraisal review system (10) after inputting a user name and password. As shown, the homepage (116) contains information (118) including review set numbers (120), creation date (122) file number (124), etc. relating to specific reviews within the review set, and information (124) relating to tasks associated with the review set. Unlike the administrator homepage (82), the reviewer homepage (116) does not include an edit button for use in association with the review set in general. Similarly, the reviewer homepage (116) does not include an add button or a remove button associated with particular reviews. Instead, the review set numbers (120) are hyperlinks to webpages associated with each review allowing the reviewer (14) to select a particular review (128). All of the reviewer's review sets, both completed and incomplete, are shown on the reviewer's homepage (116).

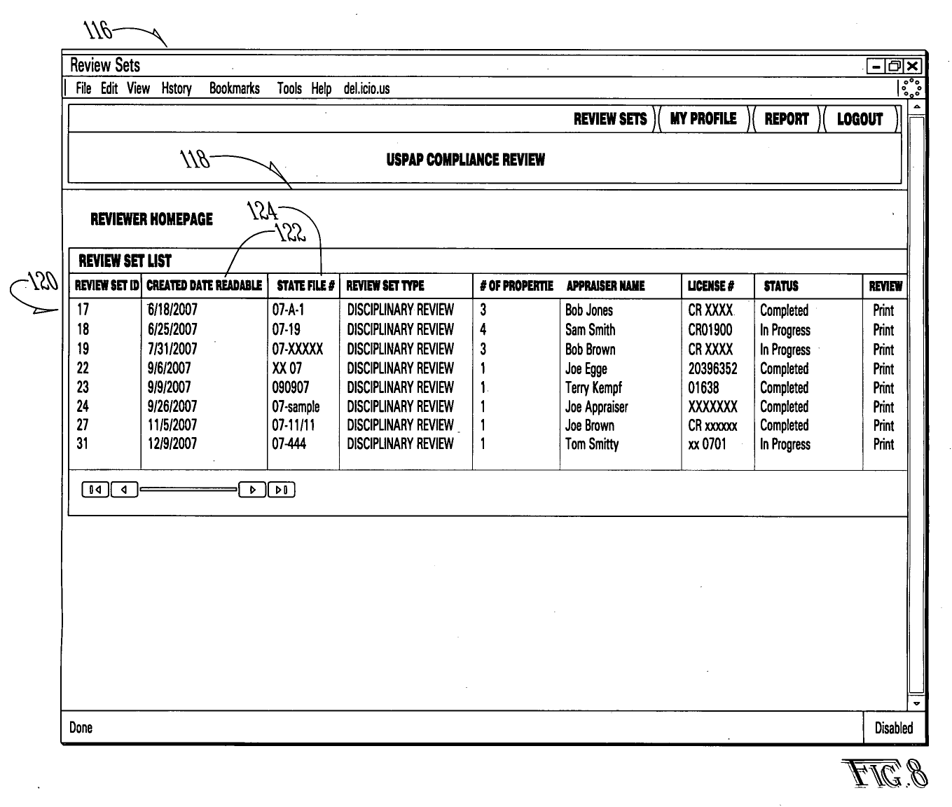

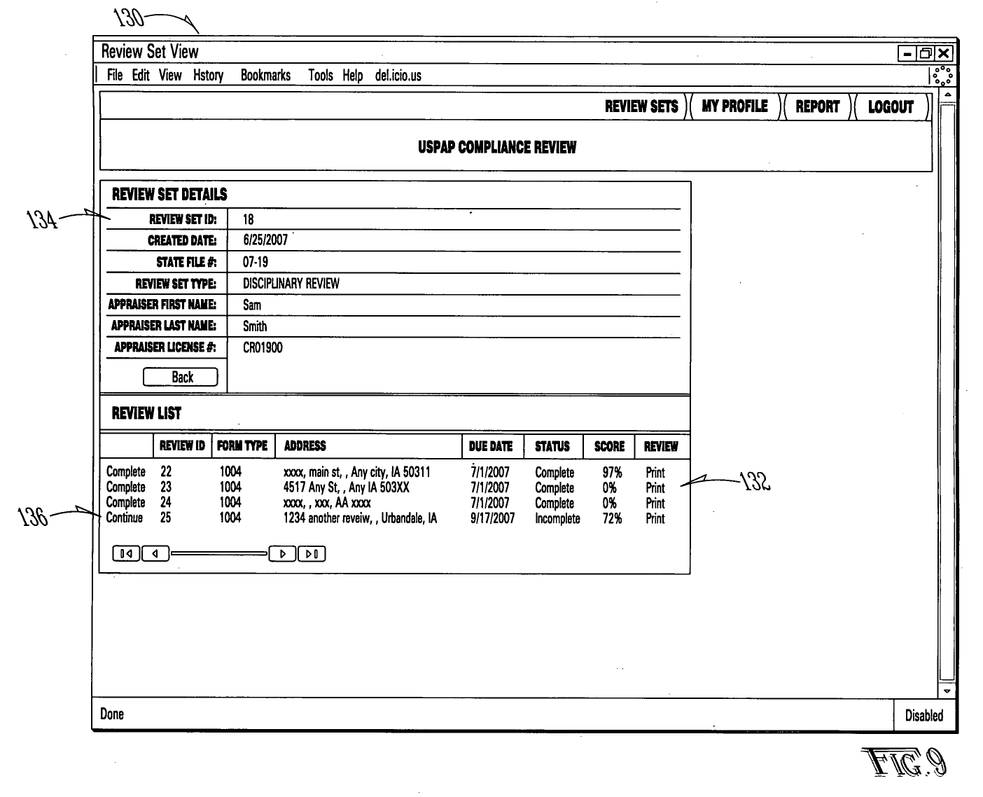

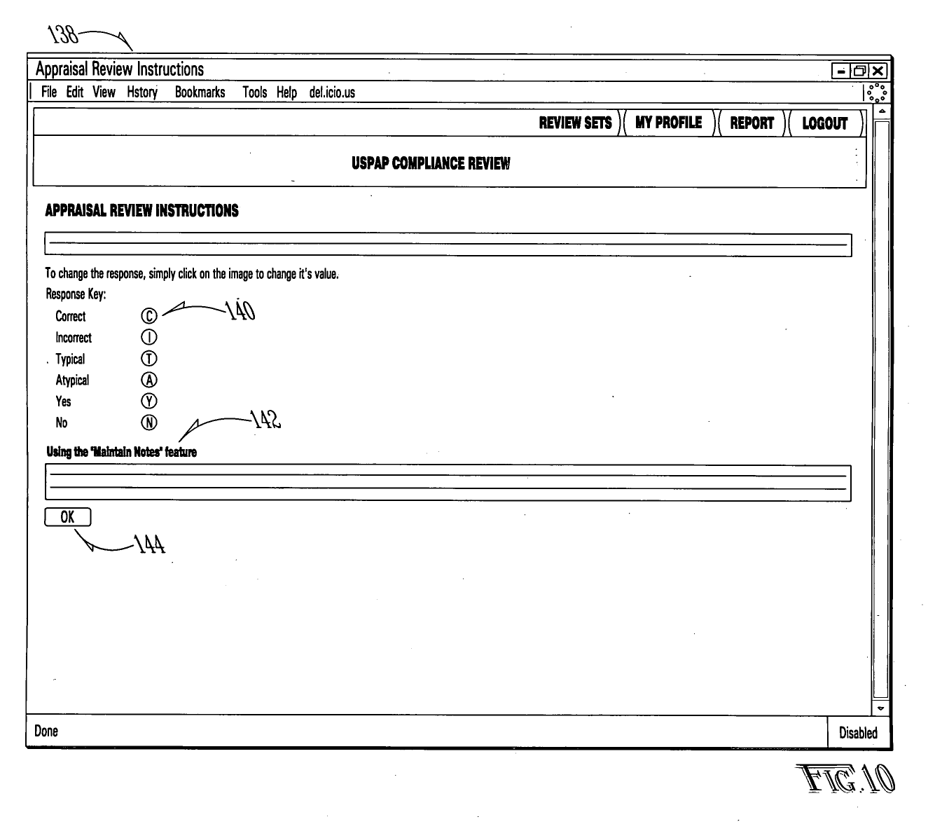

If the reviewer (14) desires to complete a review, the reviewer (14) accesses (142) the review set associated with the desired review (128) by clicking the associated review set number (120) on the homepage (116), which brings up the review set page (130) as shown in FIG. 9. The review set page (130) lists all of the reviews (132) associated with the designated set (134). For reviews (132) that are not yet completed, the reviewer (14) clicks on the hyperlink (136) designated “continue” associated with the desired review, which accesses the assessment parameters page (138) shown in FIG. 10. If desired, the assessment parameters page (138) includes a list of the assessment parameters (140) used by the reviewer (14) and associated instructions (142). Positive parameters, such as correct, typical and yes are colored green, while negative parameters, such as incorrect, atypical and no are colored red. The assessment parameters page (138) has an “okay” button (144) which the appraiser (14) clicks to access the review page (146) shown in FIG. 11.

All of the interface pages (82), (116), (130), (138) and (146) are preferably stored on the database (20) and forwarded by the server (122) through the Internet (18) to the computer displays (26) and (34) of the administrator (12) and reviewer (14) as desired. (FIGS. 1,2, 5-11). As information is input using the interfaces, the information is transferred back through the Internet (18) through the server (22) and stored on the database (20). When the reviewer (14) desires to analyze (148) a parameter such as the subject address (150) shown in FIG. 11, the reviewer (14) simply uses the input (34), such as a keyboard or mouse, to select the subject parameter (150) from the review page (146) interface screen. Once the reviewer (14) has selected a parameter, the reviewer (14) clicks on the button (150) associated with the desired parameter, such as the subject parameter.

As shown in FIG. 11, the review page (146) includes a list of assessment parameters (150) associated with the subject property (152) and comparables (154) correlated with review inputs (160) and (162). As shown in FIG. 11, the review input (160) is set to a default being that the assessment parameter identified by an appraiser on an appraisal (44) being reviewed is correct. If the assessment parameter (150) on an appraisal (44) being reviewed is not correct, the reviewer (14) uses the input (28), such as a mouse or keyboard, to select the review input (162), thereby changing (164) the review input (162) from a positive designation, such as correct or typical, to a negative designation, such as incorrect or atypical. As shown in step number (166), if the input of the reviewer (14) indicates that the appraisal is incorrect, atypical or is otherwise notable, the server (22) automatically correlates (168) a negative designation with a list of USPAP regulations (170) associated with the incorrect or atypical value noted by the reviewer (14).

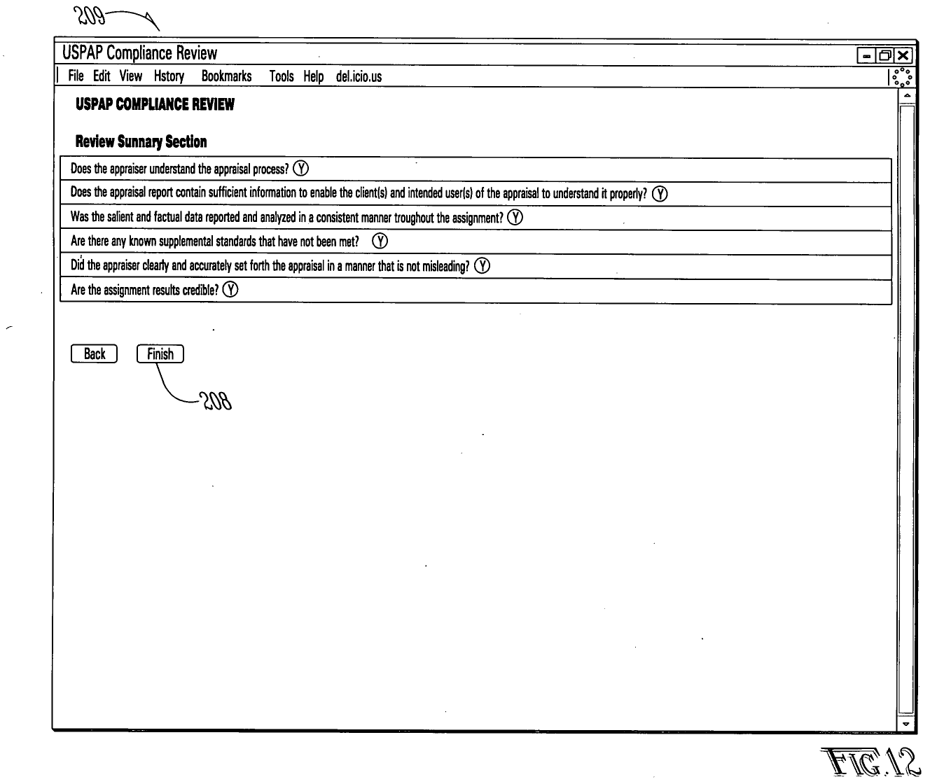

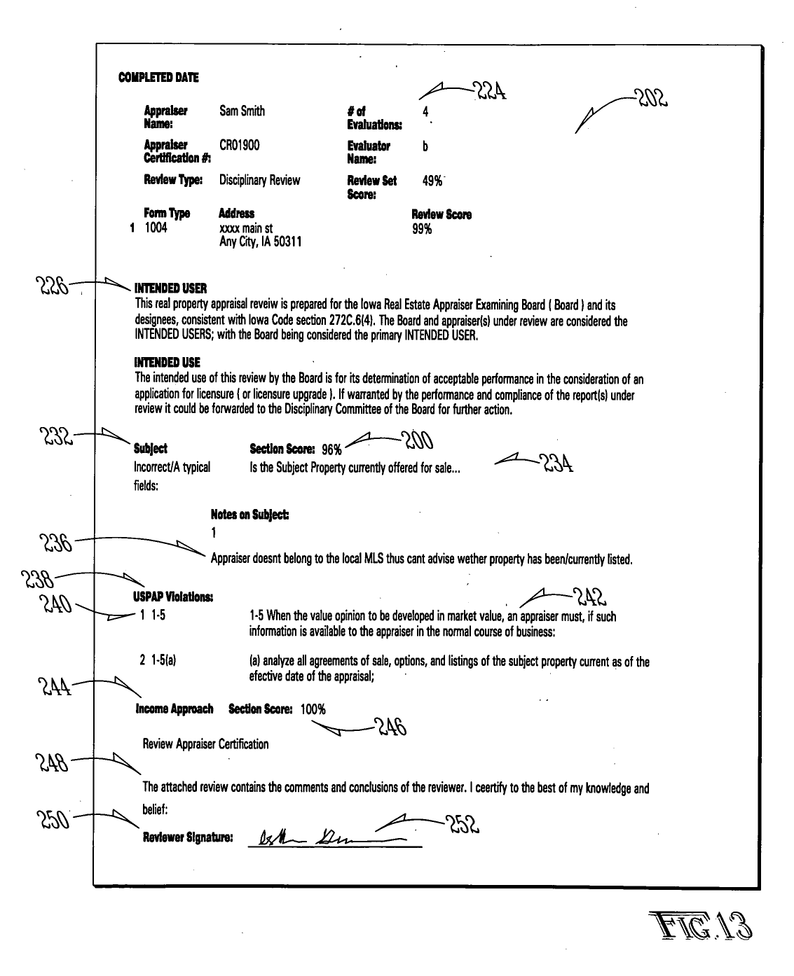

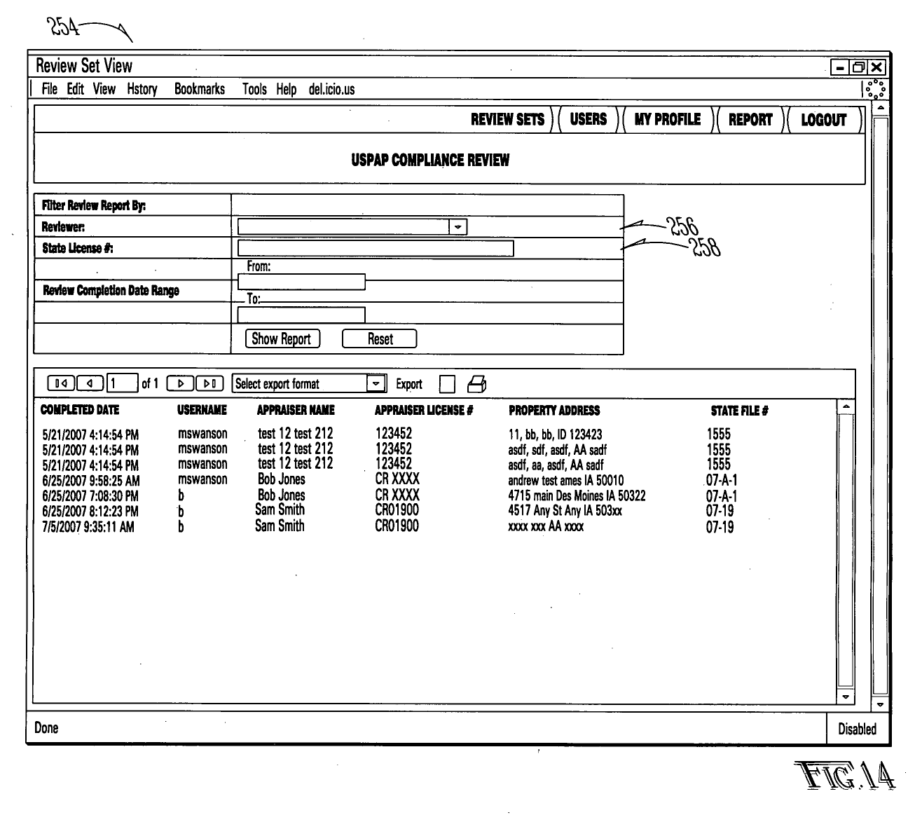

In the event the reviewer (14) indicates a review input (162) as being incorrect, atypical or otherwise notable, the system (10) automatically associates the review input with one or more regulations (170) associated with the review input (162). (FIGS. 11 and 13A-D). If the reviewer (14) decides (178) to leave commentary, such as a note (180), within the maintain notes box (182) associated with the subject section interface (152), the reviewer (14) inputs (184) a title (188) into the title box (190) and a note (180) into the note box (182) and clicks the add button (186). If desired, the note (180) may later be deleted or edited as desired.

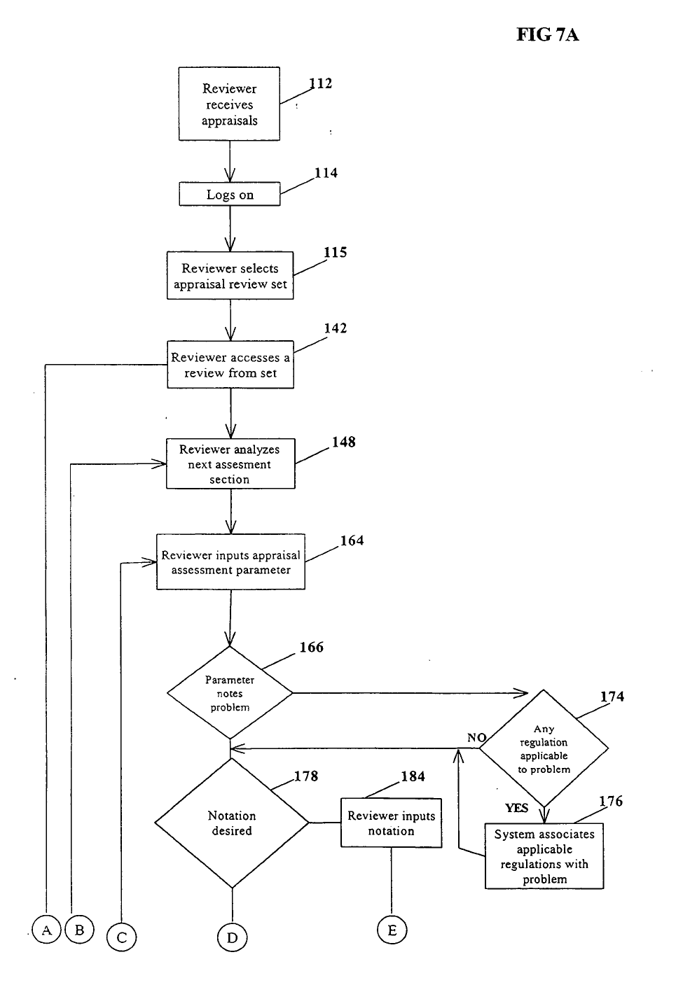

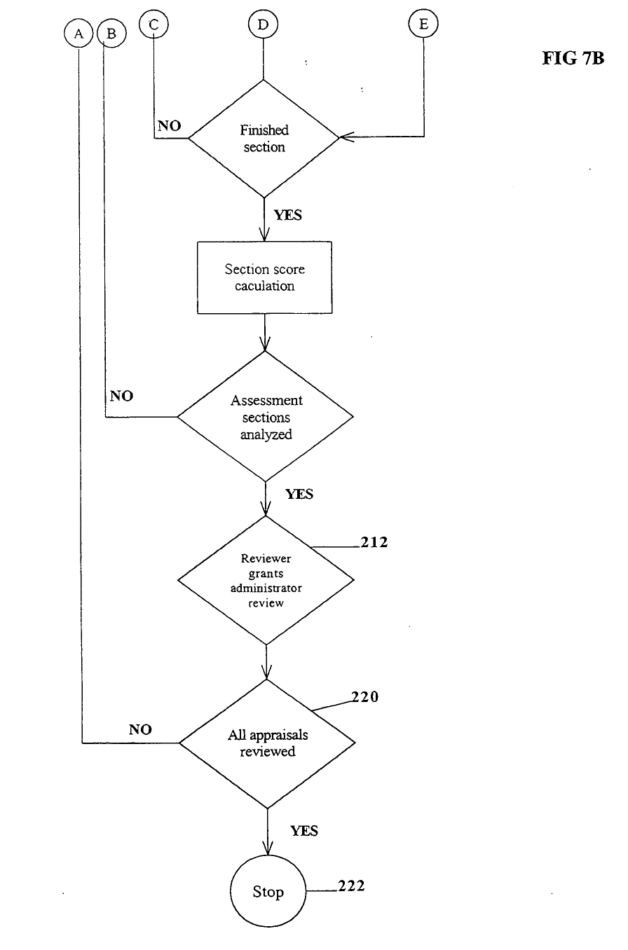

Once the reviewer (14) has left a note (180), or if the reviewer (14) does not wish to leave a note (180), the reviewer (14) determines (194) whether the particular section of assessment parameters (156) has been completed. If not, the reviewer (14) returns to the next assessment parameter (196) and returns to step (164) where the reviewer (14) inputs the desired appraisal assessment parameter (156) and note (180) if desired. Once the section (152) has been completed, the server receives the review inputs (160), (162) and (196) and the note (180), if any, from the reviewer (14) and associates them with the appropriate regulatory inputs (170) within the database (20). As shown in step (198), the server (22) also calculates the section score (200) and cumulative score (210) as shown in the finalized appraisal review (202), representing a percentage of items within a section of the appraisal (44) which are correct or typical. (FIGS. 7A-B and 13A-D).

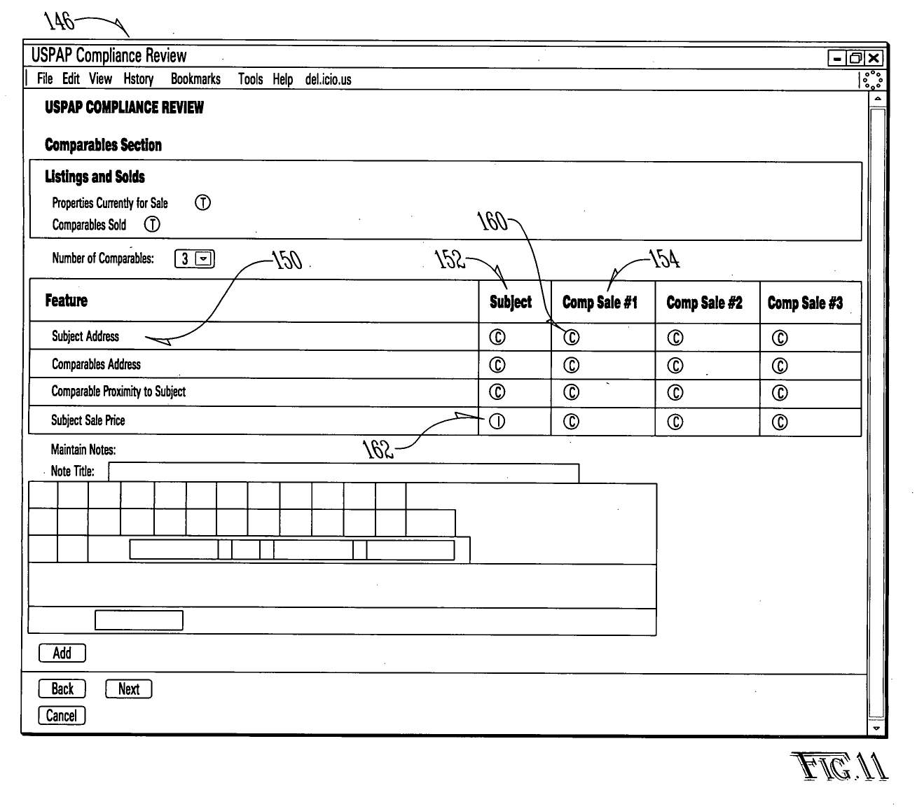

As shown in FIG. 7A-B, once a section has been completed, the reviewer (14) determines (204) whether all of the assessment sections (206) associated with the appraisal review (202) have been completed. If not, the process returns to step (148) where the next assessment section (206) is selected and analyzed. (FIGS. 1, 7A-B and 9). The process continues until all parameters associated with each of the assessment sections (206) have been completed. (FIGS. 7A-B and 13A-D). As shown generally as (209) in FIG. 12, the final review page concludes with a finish button (208) which, when selected by the reviewer (14), prevents anyone from making any additional modifications and, via the Internet (18), displays the review on the administrator's homepage (12) for the administrator (12) to review and process.

As shown in FIG. 11, the review inputs (160) notes (180) associated with the appraisal (44) may be saved by clicking the next button (214) on the information interface page (146). Alternatively, the information may be merely saved locally or on another storage system associated with the server (22) by clicking on the cancel button (216). In the event the reviewer (14) cancels the process, upon navigating back to the appraisal review (202), the system (10) displays to the reviewer (14) the last viewed page. If it is desired to return to a previous section the reviewer (14) clicks on the back button (218). In the preferred embodiment, the administrator (12) is not provided access to the finalized appraisal review (202) until the reviewer (14) clicks the finish button (208) located on the last page (209) of the appraisal review (202) to allow the reviewer (14) the chance to double check the input information, if desired. (FIGS. 1 and 12).

As shown in FIGS. 7A-B, if all of the appraisals have not been reviewed (220), the process returns to step (142) where the reviewer (14) accesses another review from the homepage interface (116). The process continues until all of the appraisals have been reviewed and the process for the reviewer (14) stops (222).

Once all of the reviews have been completed, the administrator (12) may pull up a completed appraisal review (202) such as that shown in FIGS. 13A-D. As shown, the completed review (202) includes information (224) identifying the appraisal review (202), as well as boiler plate language (226) regarding the intended user and report format associated with the review (202). The completed review (202) also a summary (230) for each section. As shown, in the preferred embodiment the summary (230) includes the heading (232), the section score (200), the listing of incorrect or atypical fields (234), specific notes or commentary (236) left by the reviewer (14), as well as a listing of the regulation sections (238), which not only includes the regulation number (240), but also the text (242) of the regulation itself. For various sections (244) the review may include only a section score (246). The inclusion of the section score provides objective criteria by which appraisers may be assessed. Actions taken in response to section scores or overall score reduce biases attributable to subjectiveness and/or inconsistencies. The review (202) also preferably includes standard certification language (248), as well as a signature section (250) for the reviewer (14), which may include a digital signature (252), or any other type of affirmation desired.

Once the review has been completed, the administrator (12) may use the search review interface shown generally as (254) in FIG. 14. As shown, the interface (254) includes search criteria related to reviewer (256), state license number (258), review completion date range (260) or any other desired criteria. Once the administrator (12) has selected the desired search criteria (264) and clicked the search button (266), the server (22) accesses the database (20) to find the requested information and provide the information to the computer (24) of the administrator (12) via the Internet (18), producing the results (268) as shown in FIG. 14.

Although the results (268) may be shown in any desired format, in the preferred embodiment the results show the completed date (270), the user name (272), the appraiser name (274), the appraiser license number (276), the property address (278), the state file number (280) as well as several other criteria. Using this search review interface (254), the administrator (12) can produce summaries of review sets handled during a particular period which may form the basis for quantitative analysis of the review sets, including the total number of reviews completed in a particular period, the average length of time to complete reviews in the period, and the number of review sets in progress during a particular period.

The search function also allows the administrator (12) to make an analysis of average appraiser performance, progress for individual appraisers and most commonly deficient sections and fields in appraisals for proper remedial measures can be undertaken. The system (10) also allows the administrator (12) to generate printouts of any desired appraisal reviews (202) or review sets at any time after completion. The analysis available using the system (10) of the present invention allows the administrator to conduct fraud investigations, work product review, disciplinary review, and to implement disciplinary processes at the federal, state and local level. The system (10) also allows the administrator to base licensure grant and upgrades upon the favorable appraisals or reviews. The system (10) also provides the administrator (12) with the ability to format results in a manner which allows the administrator (12) to more easily comply with federal regulations regarding appraiser reviews.

In the preferred embodiment, the database (20) is upgraded via the Internet (18) and server (22) with updated USPAP standards as they become available so that the server (22) is downloading the correct versions of the USPAP from the database (20) to the reviewers (14) and (16). Given the ability of the system (10) to produce summaries and search specific criteria, trends and deficiencies can be more easily noted and addressed. The system (10) is also designed to incorporate state specific regulations.

One of the primary advantages of the system (10) of the present invention is the time savings associated by remote reporting of reviews by reviewers (14) and (16), and remote access to reviews and review sets by the administrator (12). The system (10) thereby speeds the process, saving time for the administrator (12), the reviewers (14) and (16), the reporting authority (78) taking action on the data, the state attorney general in determining probable cause for investigating a particular appraiser, and other investigators having a need to access and gather data relating to the appraisal and/or review process.

Although the invention has been described with respect to a preferred embodiment thereof, it is to be understood that it is not to be so limited since changes and modifications can be made therein which are within the full, intended scope of this invention as defined by the appended claims.

What is claimed is:

1. A method of reviewing assessments comprising:
(a) providing an assessment from an evaluator to an evaluation authority,
(b) wherein said assessment comprises a set of assessment criteria,
(c) presenting through an interface system to said assessment authority a plurality of assessment parameters corresponding to said set of assessment criteria,
(d) receiving a plurality of review inputs through said interface system from said assessment authority,
(e) wherein said plurality of review inputs corresponds to said set of assessment criteria,
(f) generating a file associating said plurality of review inputs with said assessment criteria;
(g) generating an assessment score associated with said plurality of review inputs; and
(h) displaying a document associating said plurality of review inputs with said assessment score.

2. The method of reviewing assessments of claim 1, further comprising:
(a) associating a plurality of regulations with said plurality of review inputs; and
(b) displaying said regulations on said document in a manner in which said regulations correspond with at least some of said review inputs which designate a negative response.

3. The method of reviewing assessments of claim 1, wherein said plurality of review inputs are binary inputs.

4. The method of reviewing assessments of claim 1, further comprising generating a supplemental file associating said plurality of review inputs with a supplemental plurality of review inputs associated with a supplemental assessment.

5. The method of reviewing assessments of claim 4, wherein said supplemental assessment was completed by said assessor.

6. The method of reviewing assessments of claim 5, further comprising enforcing disciplinary action against said assessor based upon at least one review input from said plurality of review inputs and at least one review input from said supplemental plurality of review inputs.

7. The method of reviewing assessments of claim 1, further comprising:
(a) requesting a commentary from said assessment authority through said interface system relating to at least one review input from said first plurality of review inputs;
(b) receiving from said assessment authority through said interface system said commentary; and
(c) associating said commentary with at least one review input within said file.

8. The method of reviewing assessments of claim 1, further comprising populating a database with said plurality of review inputs and with review inputs associated with at least fifty different assessments.

9. The method of reviewing assessments of claim 8, further comprising generating from said database a file comparing at least one review input from at least ten different assessments.

10. The method of reviewing assessments of claim 9, wherein said interface system is a computer network.

11. A method of review appraisals comprising:
(a) providing a first appraisal from a first appraiser to a first reviewer;
(b) wherein said first appraisal comprises a plurality of appraisal questions;
(c) wherein said first appraisal comprises a first plurality of appraisal answers;
(d) providing a computer network;
(e) providing to said first reviewer a plurality of appraisal assessment parameters corresponding to said plurality of appraisal answers;
(f) receiving from said first reviewer through said computer network a first plurality of review inputs;
(g) wherein said first plurality of review inputs corresponds to said first reviewer's application of said appraisal assessment parameters to said first plurality of appraisal answers;
(h) associating a first plurality of regulations with said first plurality of review inputs;
(i) providing a second appraisal from a second appraiser to a second reviewer;
(j) wherein said second appraisal comprises said plurality of appraisal questions;
(k) wherein said second appraisal comprises a first plurality of appraisal answers;
(l) providing to said second reviewer a plurality of appraisal assessment parameters corresponding to said plurality of appraisal answers;
(m) receiving from said second reviewer through said computer network a first plurality of review inputs;
(n) wherein said second plurality of review inputs corresponds to said second reviewer's application of said appraisal assessment parameters to said first plurality of appraisal answers;
(o) associating a second plurality of regulations with said second plurality of review inputs
(p) providing a database; and
(q) promulgating said database with said first plurality of review inputs, said first plurality of regulations, said second plurality of review inputs and said second plurality of regulations.

12. The method of reviewing appraisals of claim 11, wherein said first plurality of review inputs and said second plurality of review inputs are binary inputs.

13. The method of reviewing appraisals of claim 11, further comprising providing feedback to said appraiser based upon at least one review input from said first plurality of review inputs and at least on review input from said second plurality of review inputs.

14. The method of reviewing appraisals of claim 11, further comprising populating said database with review inputs associated with at least fifty different appraisals.

15. The method of reviewing appraisals of claim 11, further comprising generating from said database a file comparing at least one review input from at least ten different appraisals.

16. The method of reviewing appraisals of claim 11, further comprising searching said database for data relating to said appraiser providing feedback to said appraiser based upon said data.

17. The method of reviewing appraisals of claim 11, further comprising requesting through said computer network commentary from said first reviewer relating to at least one review input from said first plurality of review inputs, receiving from said first reviewer through said computer network said commentary and associating said commentary with said at least one review input within said database.

18. The method of reviewing appraisals of claim 11, further comprising providing said plurality of appraisal assessment parameters to said first reviewer through said computer network.

19. A method of reviewing appraisals comprising:
(a) providing a first appraisal from an appraiser to an appraisal authority;
(b) wherein said first appraisal comprises a first set of appraisal criteria;
(c) presenting through an interface system to said appraisal authority a plurality of appraisal assessment parameters corresponding to said first set of appraisal criteria;
(d) receiving a first plurality of review inputs through said interface system from said appraisal authority;
(e) wherein said first plurality of review inputs corresponds to said first set of appraisal criteria;
(f) associating a first plurality of regulations with said first plurality of review inputs;
(g) generating a first file associating said first plurality of review inputs and said first plurality of regulation inputs with said first set of appraisal criteria;
(h) providing a second appraisal from said appraiser to said appraisal authority;
(i) wherein said second appraisal comprises a second set of appraisal criteria;
(j) receiving a second plurality of review inputs through said interface system from said appraisal authority,
(k) wherein said second plurality of review inputs correspond to said second set of appraisal criteria;
(l) associating a second plurality of regulations with said second plurality of review inputs;
(m) providing feedback to said appraiser based upon at least one review input from said first plurality of review inputs and at least one review input from said second plurality of review inputs; and
(n) further comprising populating a database with said first plurality of review inputs and said second plurality of review inputs.

20. The method of reviewing appraisals of claim 19, wherein said first plurality of review inputs and said second plurality of review inputs are binary inputs.
